(19) United States
(12) Patent Application Publication
(10) Pub. No.: US 2006/0255096 A1
(43) Pub. Date: Nov. 16, 2006

(54) Three-dimension shaped pad

(76) Inventors: Oliviero Dolci, Milano (IT); Emanuela Moltani, Segrate San Felice (MI) (IT)

Correspondence Address: KATTEN MUCHIN ROSENMAN LLP, 575 MADISON AVENUE, NEW YORK, NY, 10022-2585, US

(21) Appl. No.: 11/453,403

(22) Filed: Jun. 15, 2006

Related U.S. Application Data
(63) Continuation of application No. PCT/IT03/00845, filed on Dec. 19, 2003.

(51) Int. Cl. A47J 36/02

(52) U.S. Cl. 228/101

(57) ABSTRACT

The pad is constituted basically by a plurality of consecutive pages joined together; the pages are flexible and are divided into a plurality of consecutive sections; the pages of each section have the same shape; the shape of a section is contained within the shape of the next section; the shapes of the sections are such as to give rise to a subject in relief when the pad is closed; the shape of the last section is such that, even alone, it enables the subject to be recognized; the pad is adapted for resting on the last page.

This application is a continuation of International Application PCT/IT2003/000845 filed on Dec. 19, 2003, now International Publication WO 2005/058607, the contents of which are herein wholly incorporated by reference.

The present invention relates to a pad.

Pads are items which are constituted basically by a plurality of flexible pages joined together.

A back, which is generally stiff, is often provided.

A front, which is generally stiff, is sometimes provided in addition to the back.

The shape of the pages of pads is generally rectangular.

Pads are items for adults or children who are not too young; in any case, they serve for serious purposes such as, for example, for writing notes.

The present invention is based on the idea that embellishment of an item of this type with amusing elements may please the person using the item, even though for very serious purposes.

On the basis of this idea, a pad shaped in three dimensions has been devised.

The present invention relates to a pad having the characteristics set out in independent claim 1.

Further advantageous aspects of the present invention are set out in the dependent claims.

The present invention will be described below with the aid of the appended drawings, in which:

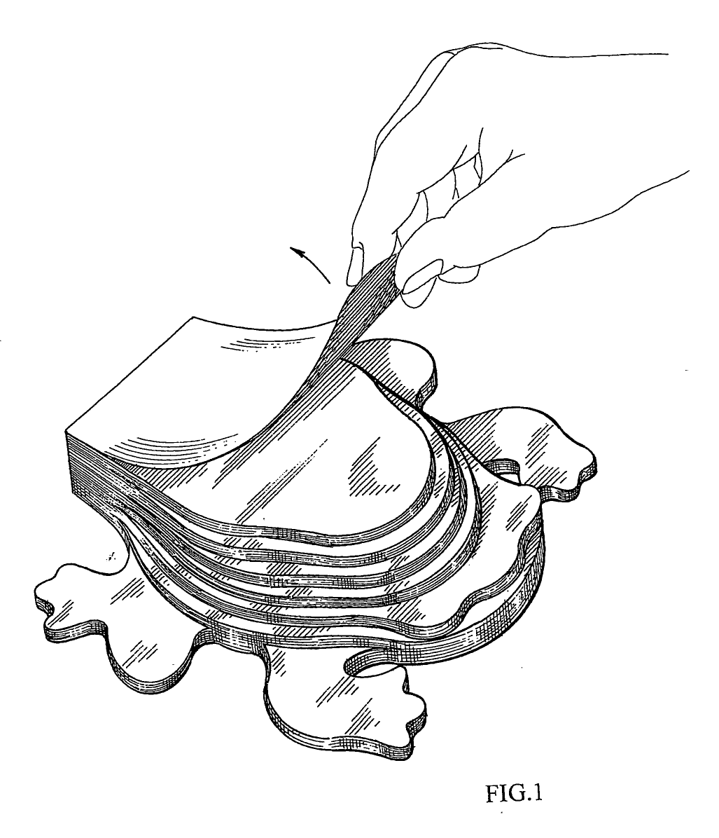

FIG. 1 shows a first embodiment of a pad according to the present invention,

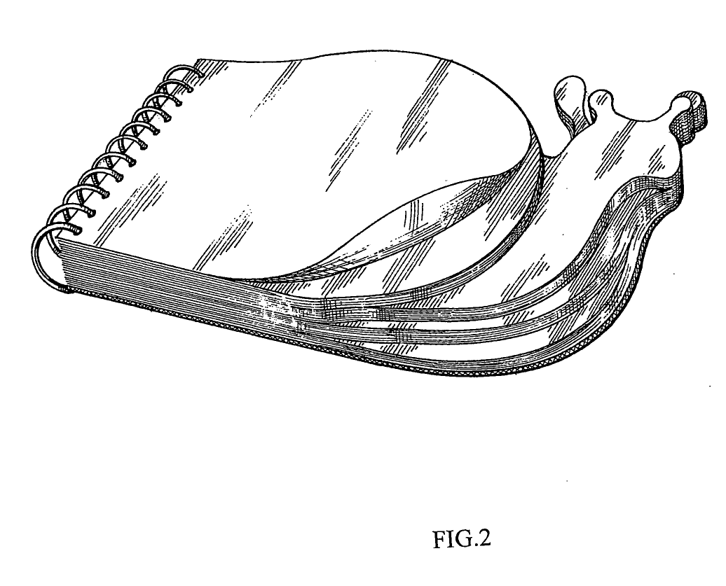

FIG. 2 shows a second embodiment of a pad according to the present invention, and

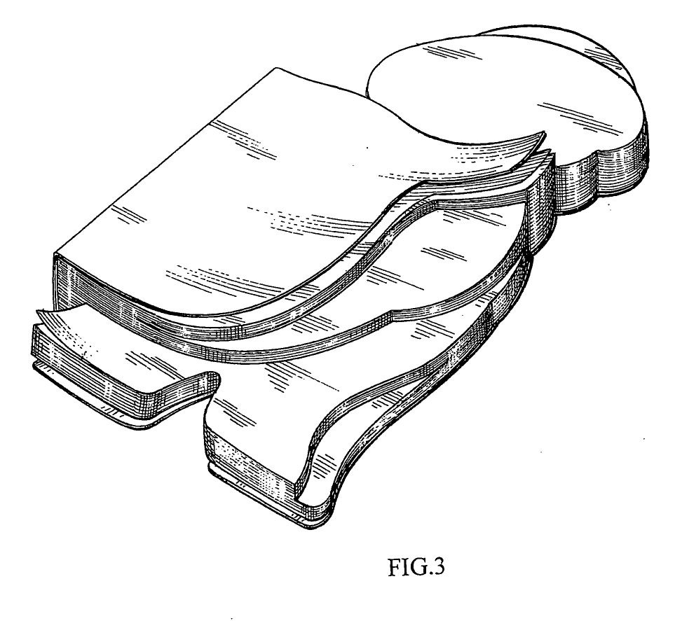

FIG. 3 shows a third embodiment of a pad according to the present invention.

The basic element of the pad according to the present invention is a plurality of consecutive pages joined together, in which the pages are flexible and are divided into a plurality of consecutive sections, in which the pages of each section have the same shape, in which the shape of a section is contained within the shape of the next section, in which the shapes of the sections are such as to give rise to a subject in relief when the pad is closed, in which the shape of the last section is such that, even alone, it enables the subject to be recognized, and in which the pad is adapted for resting on the last page.

As is clear, this element is present in the pad of FIG. 1, in the pad of FIG. 2, and in the pad of FIG. 3.

The pad of FIG. 1 is a pad of adhesive sheets which is shaped in three dimensions as a “frog”; pads of this type with square or rectangular sheets are extremely common in offices and, as is well known, are used to write notes and to insert them on the pages of a document without altering it; alternatively, the sheets may be used to insert information on the pages of a document without altering it and therefore have already-printed writing such as “CONFIDENTIAL”, “IMPORTANT”, . . . ; clearly, in this case, there is no relationship between the frog and the office work but the subject is likeable per se and therefore renders the pad more pleasing to use, even for serious purposes.

The pad of FIG. 2 is a pad of “spiral-bound” sheets which is shaped in three dimensions as a “slug”; it has a back constituted by a stiff cardboard page having the same shape as the last section; the first section, in contrast with the following sections, does not have a recognizable shape but serves for the three-dimensional portrayal of the subject; this pad can be used as pad for writing notes at school or in office.

The pad of FIG. 3 is a pad of “adhesive-bound” sheets having a back and a front constituted by two semi-rigid card pages and is shaped in three dimensions as a “snowman”; graphic elements which contribute to the visual portrayal of the snowman and to the recognizability of the subject are inserted on the front and on the peripheral strips which are visible when the pad is closed; this pad could be used, for example, for holiday (Christmas) notes; the pages of the pad could be, for example, numbered so as to provide a page for each day of the holiday.

Naturally, the pad according to the present invention may adopt a very large number of shapes; for example, the subject may be a person, a character, an animal, an object, or scenery.

The pad according to the present invention may be used for writing and/or reading for professional, teaching or amusement purposes.

The various characteristics of the basic element of the pad are analyzed below.

By means of the structure of decreasing shapes, each sheet is well supported by the underlying sheets throughout its area and there are therefore no problems, for example, in writing thereon.

The outlines of two consecutive sections may coincide in portions of greater or lesser length; typically, this occurs in the binding region, typically in a straight portion; the outline of the upper section may project from the outline of the lower section only in limited portions, forming small protuberances; in FIG. 1, the eyes of the frog, which are shown in the third section starting from the bottom, remain within the outline of the second section but, alternatively, they could project slightly.

The flexibility of the pages should be selected on the basis of the use of the pad; this flexibility depends both on the material and on the thickness of the pages.

When the pad is intact, the various superimposed shaped sections give rise to a subject; since the shape of the last section (even alone) enables the subject to be recognized, even if many of the first pages of the pad have been removed from the pad the portrayal of the subject by the pad is reduced but is not completely lost.

The pad according to the present invention may be supported in various ways: for example, it can be arranged horizontally on a table (substantially horizontal support), inserted obliquely in a support (substantially oblique support), or hung vertically on a wall (substantially vertical support).

The pages of the pad may be joined together in various different ways: for example, they may be bound at the spine by spiral binding, adhesive-binding, ring-binding, paper-binding, . . . .

In general, the pages are joined together so as to be removable from the pad without damaging its structure.

An optimal three-dimensional portrayal of a subject would be obtained by shaping each page of the pad differently; however, this would involve an increase in the production cost of the pad since it would require a very large number of sheet-cutting devices and also considerable care in the assembly of the pad.

The pad according to the present invention is a very particular item.

The subject, the way in which it is divided in shape and the form of the shapes themselves are fundamental factors for obtaining an item which is effective and can therefore have commercial success; in fact, the pad must be easy to handle, sufficiently robust, free of excessive protuberances (particularly if the pages are made of paper or similar delicate material); if the pad is to be used for writing, the pages must have a sufficiently large and concentraded area.

In addition to the basic element described above, the pad according to the present invention may further comprise a back; in this case, the pad can rest on the back.

This is the case both for the pad of FIG. 2 and for the pad of FIG. 3.

Naturally, the back may be formed in many different ways, with many different shapes, and of many different materials.

In addition to the basic element described above, the pad according to the present invention may further comprise a back and also a front; in this case again, the pad can rest on the back.

This is the case for the pad of FIG. 3.

Naturally, both the front and the back may be produced in many different ways, with many different shapes, and of many different materials.

The back may be constituted by one or more consecutive pages, preferably by a single, stiff page, as in the pads of FIG. 2 and of FIG. 3; the shape of the last section is advantageously contained within the shape of the first back page, as in the pads of FIG. 2 and of FIG. 3 which are two limit cases since the shape of the last section coincides with the shape of the back page.

The front may be constituted by one or more consecutive pages, preferably by a single, stiff page, as in the pad of FIG. 3; the shape of the last front page is advantageously contained within the shape of the first section, as in the pad of FIG. 3, which is a limit case since the shape of the front page coincides with the shape of the first section.

The most typical (and most economical) material for forming the front and/or back pages is cardboard or card.

In addition, these may be plastic-coated to a greater or lesser extent.

In any case, there are many alternatives: plastics, wood, metal, . . . .

The most typical (and most economical) material for forming the pages of the pad is paper.

One, some, or all of the pages of the pad may have a uniform colour or a uniform coloured pattern; advantageously, the colour has a logical relationship with the subject; for example, if the subject is a frog, as in the case of the pad of FIG. 1, the pages of the pad may be green or green with brown squares/stripes, or green with brown spots; if the subject is a ladybird, the pages may be red with black dots or white with black dots (the size and position of the dots may depend on the use of the pad); naturally, white and black are included amongst the colours to be considered.

One, some, or all of the pages of the pad may carry decorations or illustrations; this renders the pages more attractive and the pad therefore more pleasing to use.

The pages of the pad may advantageously have peripheral strips which bear graphic elements that contribute to the visual portrayal of the subject; in the case of the pad of FIG. 1, for example, the spots of the skin of the frog may be inserted on the strips of the pages of the various sections and the eyes of the frog may be inserted on the strips of the pages of the third section.

The central regions of the pages of the pad may have a uniform colour or a uniform coloured pattern; it is thus easier, for example, to write on the pages of the pad; this is particularly important if graphic elements are inserted on the peripheral strips; in fact the graphic elements would interfere with the writing.

Alternatively, the graphic elements of the peripheral strip may continue in the central region but with reduced colour intensity (for example, if the strip is green with brown spots, the central region is pale green with pale brown spots); the enhancement of the visual portrayal of the subject (with graphic elements) is thus maintained even across the central region of the page of the pad and any interference is rendered less annoying by virtue of the reduced colour intensity; in fact the writing will be easily visible if it is done, as it usually is, with dark ink, typically black ink.

According to a very particular embodiment of the pad according to the present invention, all or the majority of the shapes of the sections are such that, even alone, they enable the subject to be recognized.

This characteristic may be very useful if the pages of the pad are used separately from the pad; this is the case with pads of adhesive sheets; in fact, if the pad of FIG. 1 is taken and the shapes of the sections are modified slightly, all of the sheets (or a majority of them) will have a shape which looks like a frog and will therefore be more pleasing when they are applied to the pages of documents.

As is clear from the foregoing description as a whole, the pad according to the present invention may be formed in many different ways and may adopt various different shapes; limit embodiments are constituted, for example, by calendar pads and by school notebooks.

As already stated, the pages of the pads can be joined together in various different ways.

According to a very particular method of joining the pages of the pad, which is well known per se and very widespread (which gives rise to a whole class of items according to the present invention, that is, pads of adhesive sheets), the pages are joined together by means of adhesive areas disposed on the respective pages themselves so that they can easily be removed from the pad and can easily be applied to and removed from other surfaces, by virtue of their adhesive areas.

Amongst other things, this type of joining between the pages enables the shapes of the various sections to be selected with complete freedom along the entire outline of the pages.

It is thus even easier to portray the subject in three dimensions.

For reasons of cost, however, the pages will typically have a uniform colour or, at the limit, a uniform coloured pattern, decorations and illustrations preferably being avoided.

1. A pad constituted by a plurality of consecutive pages joined together, in which the pages are flexible and are divided into a plurality of consecutive sections, the pages of each section having the same shape, the shape of a section being contained within the shape of the next section, the shapes of the sections being such as to give rise to a subject in relief when the pad is closed, the shape of the last section being such that, even alone, it enables the subject to be recognized, the pad being adapted for resting on the last page.

2. A pad, according to claim 1, constituted by a plurality of consecutive pages joined together and by a back, in which the pages are flexible and are divided into a plurality of consecutive sections, the pages of each section having the same shape, the shape of a section being contained within the shape of the next section, the shapes of the sections being such as to give rise to a subject in relief when the pad is closed, the shape of the last section being such that, even alone, it enables the subject to be recognized, the pad being adapted for resting on the back.

3. A pad, according to claim 1, constituted by a plurality of consecutive pages joined together, by a front, and by a back, in which the pages are flexible and are divided into a plurality of consecutive sections, the pages of each section having the same shape, the shape of a section being contained within the shape of the next section, the shapes of the sections being such as to give rise to a subject in relief when the pad is closed, the shape of the last section being such that, even alone, it enables the subject to be recognized, the pad being adapted for resting on the back.

4. A pad according to claim 2, in which the back is constituted by one or more consecutive pages, preferably by a single stiff page, the shape of the last section being contained within the shape of the first back page.

5. A pad according to claim 3, in which the back is constituted by one or more consecutive pages, preferably by a single stiff page, the shape of the last section being contained within the shape of the first back page.

6. A pad according to claim 3 in which the front is constituted by one or more consecutive pages, preferably by a single stiff page, the shape of the last front page being contained within the shape of the first section.

7. A pad according to claim 5 in which the front is constituted by one or more consecutive pages, preferably by a single stiff page, the shape of the last front page being contained within the shape of the first section.

8. A pad according to claim 3 in which the front pages are made of cardboard or card.

9. A pad according to claim 3 in which the back pages are made of cardboard or card.

10. A pad according to claim 1 in which the pages of the plurality are made of paper.

11. A pad according to claim 1, in which one, some, or all of the pages of the plurality have a uniform colour or a uniform coloured pattern, in which the colour preferably has a logical relationship with the subject.

12. A pad according to claim 1 in which one, some, or all of the pages of the plurality carry decorations or illustrations.

13. A pad according to claim 1 in which the pages of the plurality have respective peripheral strips which carry graphic elements that contribute to the visual portrayal of the subject.

14. A pad according to claim 13, in which a central region of the pages of the plurality has a uniform colour or a uniform coloured pattern.

15. A pad according to claim 13 in which the graphic elements of the peripheral strip continue in the central region but with reduced colour intensity.

16. A pad according to claim 1 in which all or the majority of the shapes of the sections are such that, even alone, they enable the subject to be recognized.

17. A pad according to claim 1 in which the pages of the plurality are joined together at the spine by binding.

18. A pad according to claim 1 in which the pages of the plurality are joined together by means of adhesive areas disposed on the respective pages themselves so as to be easily removable from the pad, and are easily applicable to and removable from other surfaces by virtue of their adhesive areas.
